(19) United States
(12) Patent Application Publication
(10) Pub. No.: US 2015/0273251 A1
(43) Pub. Date: Oct. 1, 2015

(54) FIRE SACK

(71) Applicant: Scott SPORRE, Forest Hill, MD (US)

(72) Inventor: Scott SPORRE, Forest Hill, MD (US)

(21) Appl. No.: 14/226,035

(22) Filed: Mar. 26, 2014

(51) Int. Cl. A62C 8/06

(52) U.S. Cl. CPC A62C 8/06

(57) ABSTRACT

The present invention provides a fire sack for the quick and safe extinguishing of household, office, retail, commercial, and medical appliance and device fires. The fire sack includes an outer layer of sturdy canvas and an inner layer of fire-retardant material, preferably wool fire blanket material. The fire sack has two or more handles to assist in quickly placing the fire sack over a burning, smoking, melting or flaming appliance, and one or more drawstrings to quickly close the fire sack around a burning, smoking, melting or flaming appliance. The fire sack can be used to transport the device or appliance to a safe location, and avoids the mess and potential damage of fire extinguishing liquids or foams.

### BACKGROUND OF THE INVENTION

1. Field of the Invention

This invention relates to the extinguishing of small fires, particularly small appliance, device or equipment fires.

2. Background Information

Various small appliances, in every setting, including residential, retail, commercial, medical, etc., are subject to catch fire due to wiring defects or damage, contact with water or other liquids, and other malfunctions or damage. The current way to put out such fires is usually to use a fire extinguisher. Accordingly, fire extinguishers are ubiquitous in such settings. When fire extinguishers are not readily available, water is used, and, if available, blankets are sometimes used by the quick-thinking. The problem with fire extinguishers is that they are sometimes hard to use and hard to control; they are almost always messy, and they are sometimes much more than is required for small appliance fires. Throwing water in a fire is often ineffective, always messy, and sometimes dangerous. The use of blankets to smother a fire can be safe and effective, but that typically depends on the skill and confidence of the user, as well as the ability of the user to think of using a blanket under the stress of an emergency situation.

### SUMMARY OF THE INVENTION

The present invention overcomes the disadvantages of prior art methods and devices for putting out small appliance fires by providing a fire proof sack, sized appropriately to be quickly and easily placed over an appliance that has caught fire, that has a quick-cinch closure device that allows the user to quickly close the sack once it has been placed over the appliance in order to suffocate the flames. The present invention may thus be used to quickly and easily contain and extinguish fires, while preventing the escape of dangerous fumes. The invention may also be used to conveniently transport the item to a safe location without danger of spreading the fire, causing burns to the user or other materials, and/or the spreading of smoke and fumes. The invention has the additional advantage that it allows for the inspection of the device to determine the cause of the fire, without having to remove flame extinguishing chemical or foam that might also interfere with determining the cause of the fire.

According to preferred embodiments, the present invention may be used in circumstances where a liquid or foam fire extinguisher is not available, and/or where the discharge of a liquid or foam fire extinguisher might be dangerous, unpleasant and/or messy. The present invention is particularly suitable for home use where it may be quickly used to contain kitchen appliances that are smoking, melting or flaming. The present invention also prevents noxious smoke from spreading through the home during or after the extinguishing of a small appliance fire. In a laboratory setting, the invention can also be used to quickly extinguish small equipment fires, preventing the contamination of the lab area by liquid or foam extinguishing chemicals or fumes from the extinguished fire.

According to other embodiments, the fire sack of the invention may be used to contain and extinguish small appliance and device fires in planes, trains, automobiles, and buses. The fire sack of the invention is also well suited for containing and extinguishing small equipment and device fires in office settings. For example, the fire sack of the invention is perfect for extinguishing fires in computer monitors, laptops, desktop computers, and similar devices. Many devices and equipment have batteries or wiring that are susceptible to spontaneous fires under certain conditions. The fire sack of the present invention is perfectly suited for containing and extinguishing such fires, as well as allowing for the easy transport and inspection of such devices.

According to a most preferred embodiment of the invention, the fire sack is sized to receive and contain portable medical equipment of the type that is ubiquitous in hospitals, nursing homes, and other medical settings. Heart rate and blood pressure machines may be found in every patient room, as well as in numerous common areas in hospital and other medical settings. Such devices are often positioned on a pole furnished with wheels at the base to make the device portable/roll-able. According to this embodiment, the fire sack of the invention is sized to allow it to be quickly and easily placed over the device, including the mounting pole, and then cinched shut around the pole beneath the device to cut off oxygen, extinguishing the flames and preventing the exit of smoke, fumes or odors. The fire sack can be kept in place as the device and the pole are moved to a safe location, even as the fire is still being extinguished, without endangering persons or property, or spreading smoke and fumes throughout the facility.

According to various embodiments, the fire sack of the invention may be made of one or more fire retardant materials and/or treated with fire retardant chemicals. According to a preferred embodiment, the outside layer of the sack may be made of heavy canvas material, or the like, for example of the types from which fire hoses and fire fighter coats are manufactured. The fire sack of the invention may include multiple layers of such fabric and/or may include a liner made of the same or different material. If made of a different material, the liner may be made of flame retardant fabrics, and/or fabrics that are treated with flame retardant chemicals. According to a preferred embodiment, the liner may be made of woolen fire blanket material. The liner, if provided, may be permanently stitched to the interior of the outer liner, or it may be removable so that it can be replaced, if necessary, after it has been used to contain or extinguish a smoking, melting or burning appliance. Even if the liner is not damaged by fire after use, it may absorb unpleasant odors.

According to a preferred embodiment, the fire sack may be provided with handles on the outside to assist with the placement of the fire sack over the smoking, melting or burning device. According to one embodiment, handles may be placed on each side of the sack, within two to six inches from its opening. According to other embodiments, additional handles may be provided on the side of the sack more distal from the opening, for example at or near the midpoint of the fire sack along its length.

According to another embodiment, the fire sack of the invention may be permanently closed at one end, and closeable by a draw string at or near the opening side of the sack. According to a preferred embodiment, the drawstring may be fitted with a spring-loaded drawstring stop to keep the sack in the closed position after it has been cinched shut to contain a melting, smoking, burning or flaming appliance. According to a preferred embodiment, a drawstring may also be provided at or near the mid-point of the fire sack to create a smaller containment space in case the melting, smoking, burning or flaming device only takes up space at one end of the fire sack.

### BRIEF DESCRIPTION OF THE DRAWINGS

Various features and advantages of the disclosure will become more apparent by the following detailed description of several embodiments thereof with reference to the attached drawings, of which:

FIG. 1 is a perspective view of a fire sack according to the invention;

FIG. 2 is a front view of fire sack with its mouth opened;

FIG. 3 is a plan view of a step in the assembly of one embodiment of a fire sack according to the invention.

FIG. 4 is a plan view of a fully assembled fire sack according to one embodiment of the invention.

### DETAILED DESCRIPTION OF THE INVENTION

The contents of all references cited herein are to be considered to be incorporated within this disclosure by this reference.

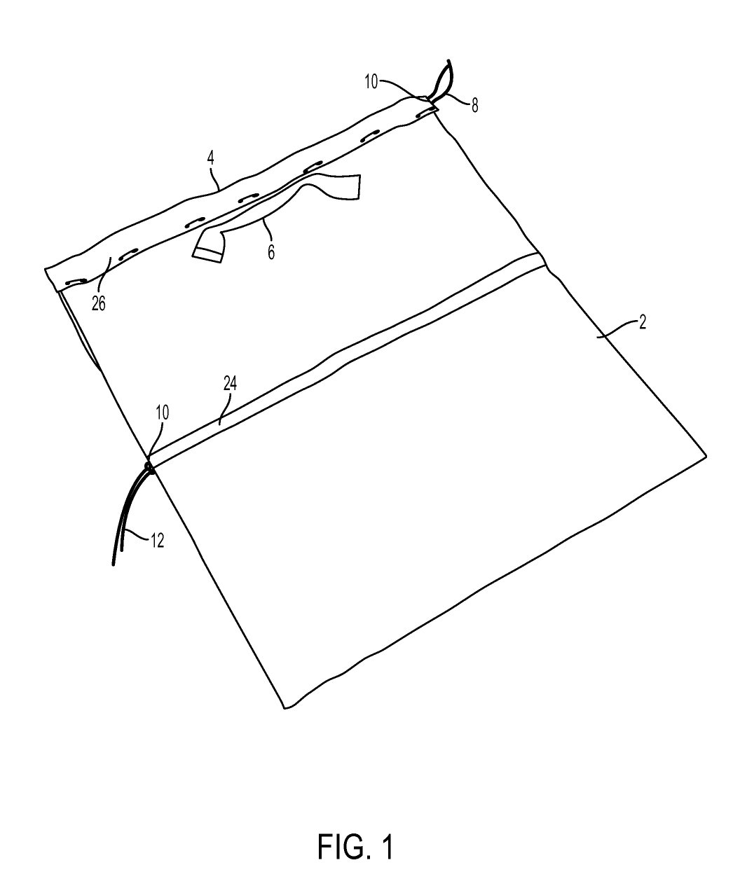

Referring to FIG. 1, a fire sack of the invention may be made of a sturdy exterior layer 2, preferably made of durable canvas of the type used to make fire hoses and/or fire fighter wear, and inner layer 4, made of fire resistant fabric, or other fabric treated with fire-retardant chemicals. Inner layer is preferably made of wool fire blanket material. Handles 6 may be provided at or near the opening of the fire sack for ease of use and handling. The fire sack may have a drawstring 8 at the mouth of the fire sack to allow for quick closing of the sack. Spring loaded drawstring stop 10 may be provided to keep the drawstring closed after it has been placed over a burning, melting, flaming and/or smoking appliance or other device. A second drawstring 12 may be provided at or near the mid-point of the fire sac to enclose appliances that are smaller than the volume of the full fire sac. Second drawstring 12 may also be provided with a drawstring stop 10.

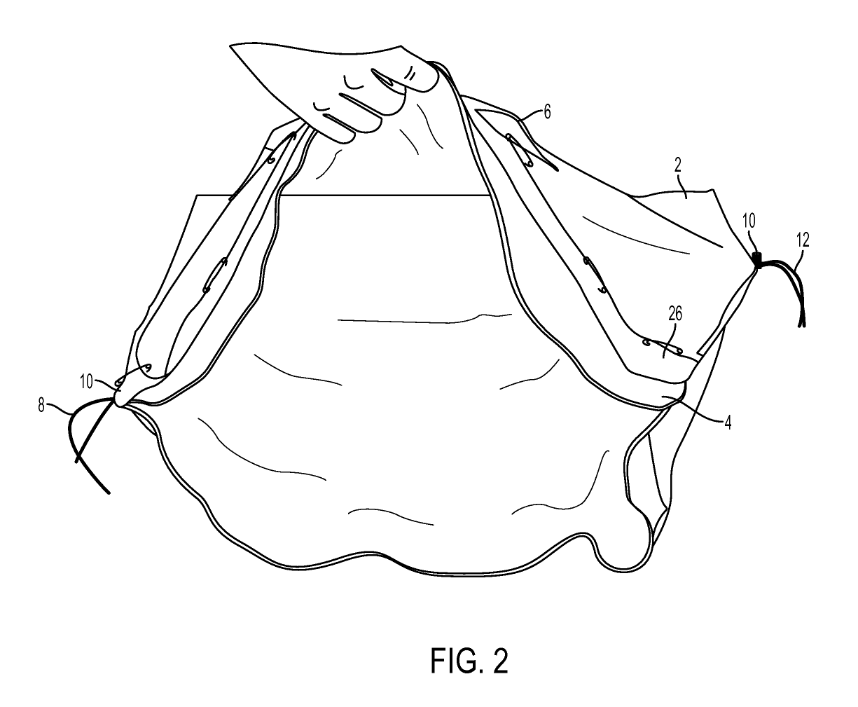

FIG. 2 shows the fire sack of FIG. 1, opened at the mouth to receive a smoking, melting, burning and/or flaming device or appliance. FIG. 2 shows how a fire sack of modest dimensions can easily open wide enough to receive and enclose many small and medium residential, commercial, retail, medical, and other devices and appliances, after which either or both of drawstrings 8 and 12 may be pulled tight and secured with drawstring stops 10.

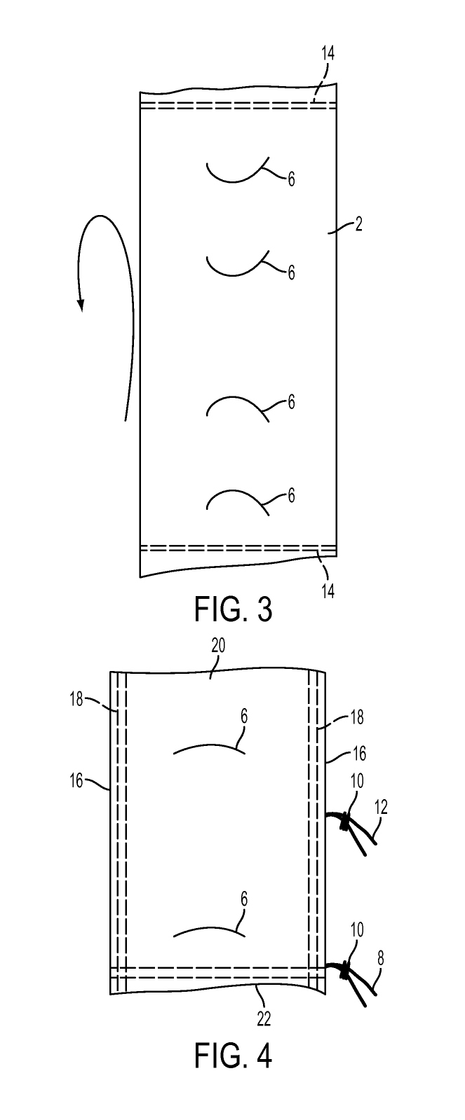

FIG. 3 is a representation of a piece of heavy canvas fabric that might be used to form the exterior layer 2 of a fire sack of the invention. Beneath the heavy canvas fabric, and therefore not shown in FIG. 3, is the interior layer 4, preferably made of a similarly sized and shaped piece of wool fire blanket material or other fire-resistant material. According to the embodiment shown in FIG. 3, interior layer 4 and exterior layer 2 are stitched together at each end with end stitching 14, and handles 6 are stitched to the exterior layer 2.

FIG. 4 shows the next step in the assembly of one embodiment of a fire sack according to the invention, in which the external and internal layers, having been stitched together at each end as shown in FIG. 3, is folded over at the midpoint, with the interior layer 4 on the interior and the exterior layer 2 on the exterior, and the edges 16 of the fire sack are stitched together with edge stitching 18, to form a fire sack of the invention with bottom 20 and mouth 22, with the edge stitching going through both edges of the exterior layer 2 and the interior layer 4 (in the case of the non-removable interior layer). Drawstrings 8 and 12 can be provided between the interior layer 4 and the exterior layer 2, in which case they are preferably put in place before edge stitching is done, or they can be provided on a channel 24 stitched to the exterior of the exterior layer 2, and in the case of the drawstring 8 at the mouth 22 of the fire sac, a drawstring channel may be formed by folding back the ends of the exterior layer in the form of a cuff 26 which is then stitched to itself.

In the case where the interior layer is to be removable, the material of the interior layer is narrower than the width of the material of the exterior layer, and each of the exterior layer and the interior layer is separately formed, but folding over each at the midpoint, and stitching each edges separately form two sacks, one external and one internal. The internal sack is then slid into the external sack. After one or more uses, if the internal sack is damaged or retains a foul odor, then the external sack may simply be removed and replaced with another one.

In use, the fire sack of the invention may be placed in convenient and prominent/visible locations throughout a home, office, business, retail establishment, hospital, clinic, nursing home, and the like, preferably close to a fire extinguisher. When a small appliance or other electronic device is smoking, flaming or melting, a user simply retrieves the fire sack, pulls it over the appliance, cinches it closed using the drawstring and removes the device to a safe location for inspection. Closing the fire sack with the drawstring prevents the entry of oxygen into the fire sack and extinguishes any fire. Once the fire has been extinguished, the fire sack may be returned to its prominent storage location.

The specific description herein is intended as an example only and is not intended to limit the invention. Other embodiments falling within the scope of the claims herein are considered to fall equally within the scope of this invention.

What is claimed is:

1. A fire extinguishing sack, comprising:
an exterior layer formed of fire-resistant canvas;
an interior layer formed of a fire-resistant material;
a drawstring at or near a mouth of said sack configured to reversibly close said sack;
one or more handles affixed to an exterior side of said sack.

2. A fire extinguishing sack according to claim 1, further comprising a second drawstring, situated at or near a midpoint of said sack.

3. A fire extinguishing sack according to claim 1, wherein said interior layer is permanently affixed to the interior of said exterior layer.

4. A fire extinguishing sack according to claim 1, wherein said interior layer is removable and replaceable without the need to remove stitching.
